(19) United States
(12) Patent Application Publication
(10) Pub. No.: US 2007/0129831 A1
(43) Pub. Date: Jun. 7, 2007

(54) Method for at-factory pre-assembly of a transportation system, and assembly plant for manufacturing a transportation system

(76) Inventors: Gerry Encinas, Giesshuebl (AT); Michael Matheisl, Vienna (AT)

Correspondence Address: SCHWEITZER CORNMAN GROSS & BONDELL LLP, 292 MADISON AVENUE - 19th FLOOR, NEW YORK, NY, 10017, US

(21) Appl. No.: 11/634,632

(22) Filed: Dec. 6, 2006

(30) Foreign Application Priority Data
Dec. 7, 2005 (EP) EP 05 111810.7

(51) Int. Cl. G06F 19/00

(52) U.S. Cl. 700/95

(57) ABSTRACT

An assembly plant for at-factory pre-assembly of transportation systems has several assembly stations. In every assembly station a part of a respective transportation system is pre-assembled at each station. The assembly stations are arranged in the sequence of the assembly steps that are to be executed, and have assembly-step-specific tool devices and devices for making ready an inventory of assembly-step-specific assembly components. A production control system controls execution of the assembly steps and individual movement of the transportation systems between assembly stations, such that each transportation system is alternately moved and subjected to assembly steps. The assembly steps proceed in a rhythm (T) that is defined by a pre-specified fixed standard assembly-time window T.

The subject of the invention is a method and an assembly plant for the at-factory pre-assembly of a transportation system that is embodied as an escalator or moving walk.

### BACKGROUND OF THE INVENTION

Until now, transportation systems were individually pre-assembled at individual installation sites and sometimes moved with the assistance of overhead cranes.

Such transportation systems are characterized by high weight and long length. The weight of an escalator is typically in the range of 10 tons, and the length of an escalator can be 30 meters or more. These transportation systems are difficult to move and require the use of powerful overhead cranes that can only produce slow movements.

With the present state of the art, various escalators in an assembly workshop are arranged parallel to each other in a particular sequence. The position of the escalator in the sequence corresponds to a predefined status of processing. Occupying the first position is only the pre-assembled truss of the escalator. In the last position, sheet-metal covers are mounted on the then-finished escalator. Each escalator is moved by the overhead crane into a next position and can remain in each position for up to three or four days. The escalators are processed independent of each other and also moved independent of each other into a next position. After 10 to 15 days, the escalator has normally passed through all the installation steps.

Disadvantageous is that on account of their length, the escalators cannot be arranged one after the other because the resulting length of the escalator systems would rapidly exceed the length of the assembly workshop. The escalators are also kept in their positions for as long as possible because they are difficult to move.

This type of pre-assembly affords little flexibility, is difficult to plan and control, causes relatively high costs, and requires much time.

The task therefore arises of providing a method that makes the pre-assembly of large and bulky transportation systems more readily plannable and, above all, controllable.

A further task is to make the pre-assembly controllable and therefore to be able to coordinate the various processes with each other to the greatest possible extent so as to save costs.

The objective of the present invention is to improve the known manufacturing technologies for escalators and moving walks and to reduce the costs of manufacture for such transportation systems.

With the method according to the invention that is described below, it is possible to standardize the pre-assembly process of a transportation system and at the same time, by means of additional optional steps, to flexibly adapt the pre-assembly process to customer needs. The truss frames that are used in the method make it possible to relocate the escalators individually in an assembly workshop. For it to be possible to move the escalator systems, special transport vehicles can be used that depend on the respective embodiment.

### BRIEF DESCRIPTION OF THE INVENTION

In accordance with the invention, the solution to this task is a method of at-factory pre-assembly of a transportation system in a series of assembly steps executable in an assembly plant with assembly stations in which station-specific assembly steps are executed at an assembly station on a transportation system or transiently or momentarily present in the area of the assembly station and the execution of transfer steps to move the transportation systems individually to the next assembly station. The assembly and transfer steps are controlled by a production control system such that the transportation systems are alternatively subjected to transfer and assembly steps at a rhythm that is defined by a specified fixed standard assembly-time window.

An assembly plant in accordance with the invention is characterized by a series of assembly stations for the transportation systems being assembled, arranged in the sequence of the assembly steps to be executed. Each assembly station has assembly step-specific equipment to perform the step, and devices to make ready the required invention for assembly step-specific components. A production planning system is linked with at least one of the assembly stations to control or initiate execution of the assembly steps and individual movement of the transportation system between assembly stations such that a given transportation system under assembly is alternately moved and subjected to an assembly step, the assembly steps proceeding in a rhythm defined by a fixed standard assembly-time window.

The present invention solves the task by foreseeing several assembly steps for the at-factory pre-assembly of a transportation system that is embodied as an escalator or moving walk. These steps are performed in assembly plants with several assembly stations, several transportation systems being in the assembly plant simultaneously for pre-assembly.

In the area of the assembly stations, station-specific assembly steps are performed on a transportation system that is temporarily present in the area of the assembly station.

Between the assembly steps, the transportation systems are moved individually in transfer steps from one assembly station to an assembly station following thereupon, execution of the assembly steps and performance of the transfer steps in the assembly plant being controlled by a production control system in such manner that the transportation systems are alternately subjected to transfer steps and assembly steps. The assembly steps in the assembly plant proceed in a specified, defined rhythm that is defined by a standard assembly-time window.

This has the advantage that individual assembly stations can be equipped with special tools that are only required at one point in the production procedure. By means of this specialization of the assembly stations, costs can be saved in the infrastructure of the assembly stations. The individual production steps of a transportation system are split up into small, manageable production steps and thereby standardized to the greatest possible extent. Optimization methods in the production process thereby become more readily identifiable and can be efficiently implemented. By separation into smaller production steps, disruptions in the production process can also be more easily isolated and remedied. Furthermore, the workshop in which an assembly plant according to the invention is located is less elaborate in its construction since no more crane trolleys or lifting cranes are required in the ceiling area of the workshop.

The parts that are required to be assembled in the pre-assembly process can be made ready directly at a place that is advantageously at the required assembly station.

The production control system can control and monitor the entire assembly plant. This allows inquiries to be made of the production system regarding the current status of production of the transportation systems that are present in the pre-assembly process.

Advantageously, all assembly steps are divided into standard assembly-time windows. Through a correspondingly designed production control system, the assembly of several transportation systems in the assembly plant proceeds in time-synchronized manner.

This has the advantage that the pre-assembly of transportation systems allows simpler and more accurate planning of the manufacturing processes and production. The time-synchronized form of the assembly plant results in an essentially constant production of transportation systems in the assembly plant per unit of time.

Advantageously, the transportation systems that are present in the assembly plant are monitored and controlled by the production control system in such manner that on expiration of a standard assembly-time window, transfer steps are executed to move the transportation systems individually to their respective next assembly stations.

This has the advantage that, in a fully utilized assembly plant, at each assembly station there is always a transportation system on which the work that is foreseen in the assembly station is being performed.

Advantageously, the production control system takes measures to shorten the elapsed assembly-time actually required at an assembly station should it be expected that this assembly station will be blocked by assembly steps that take too long and the rhythm thereby disrupted. This could be, for example, through the readying of resources and/or through the readying of components that are pre-assembled to a higher degree and/or through the additional readying of assembly workers. The production control system can also, or in addition, control the assembly plant in such manner that following after a transportation system that is time-intensive to assemble, a transportation system that is less time-intensive to assemble passes through the assembly stations.

This has the advantage that the rhythm of the assembly plant can be held constant. By readying components that are pre-assembled to a higher degree, the work-time in the assembly station can be reduced. The corresponding pre-assembly can take place at a workplace inside or outside the assembly plant. Through the additional readying of assembly workers, faster processing of the job at an assembly station is achieved. By advantageous planning of transportation systems that require more or less time than the standard assembly-time window, a limited deviation from rhythm of the standard time window can be tolerated without impairing the rhythm of the assembly plant.

Advantageously, the assembly stations are arranged in the sequence of the assembly steps that are to be executed and have assembly-step-specific tool equipment as well as equipment for readying an inventory of assembly-step-specific assembly components.

This has the advantage that the transportation systems can be transported from the first to the last assembly station in the rhythm that is defined by the standard assembly-time window without any work-step being omitted. By specialization of the assembly stations, special tool devices need only be provided at the assembly stations where they are required. Procurement and maintenance costs for the assembly stations are thereby reduced. Through provision of an inventory of assembly-step-specific assembly components directly by the assembly station, unnecessary distances for the assembly workers can be saved.

Advantageously, the assembly plant contains at least one transport vehicle to individually move a transportation system that is to be preassembled from one respective assembly station to the next assembly station.

This has the advantage that the transportation systems can be moved in the assembly plant without great expenditure of strength. With a transport vehicle, and depending on its degree of completion, the truss frame can be easily accelerated and decelerated. Safe maneuvering in the production plant is thereby made possible. With the aid of the transport vehicle, the transportation systems can also be moved from the assembly stations into passing stations.

Advantageously, the production control system is a computer aided production control system that uses sensors and output units to control, and correctively intervene in, the pre-assembly of several transportation systems.

This has the advantage that the production control system is always informed by sensors about the current status of the pre-assembly and can cause the corresponding items of information to be taken into account in the production process. Via the output units, items of information can be output that advantageously affect the production process. Because the production control system is computer aided, access to production data by other computers via a network such as, for example, the Internet or an intranet, is also possible. The production control system can also be connected to planning software.

Advantageously, the transportation systems are mounted and transported on truss frames that preferably have rollers mounted on or under the truss frame.

This has the advantage that, after pre-assembly, the transportation systems can be delivered to final assembly with the truss frame. Through the rollers being mounted on or under the truss frame, movement of the truss frame before assembly, after assembly, or in the assembly plant is possible without difficulty.

Advantageously, the devices for readying an inventory are devices that are organized according to the Kanban principle. This has the advantage that no central production control system need be present, and the individual assembly plants can autonomously manage their need for parts needing to be newly mounted. By means of Kanban cards, the supplying point is informed of the need for parts. As a result, no large inventories are needed in the assembly plant.

Advantageously, the production control system is linked to a just-in-time system. This has the advantage that the outlay for inventory holding, and therefore the outlay in terms of tied-up capital, can be reduced. Furthermore, there is no threat of obsolescence of inventories.

Advantageously, the production control system triggers readying of material needed by a respective assembly station so promptly that no delays occur in the assembly process, the material being preferably readied in ordered material wagons.

This has the advantage that in the assembly plant no delays or shortages occur at the assembly stations during the assembly process. Thanks to the ordered material wagons, all of the parts for assembly of an order can be readied. At the same time, a check of the quantity and quality of the parts for assembly can take place. Furthermore, there is only ever as much material as is actually needed in the assembly station. This allows the inventory costs to be reduced.

Advantageously, in an assembly plant at least one of the following assembly stations is present: a preparation station, a station for the installation of electrical components, a station for the mounting of balustrades and/or steps, a test station for testing the pre-assembled transportation systems, and a packing station.

This has the advantage that individual specialized work-steps can be efficiently executed at the assembly stations. Because of the modular construction, individual assembly stations can be omitted depending on the transportation system or order.

It is preferable for at least one passing station to be provided to allow a transportation system to be temporarily removed from the pre-assembly process and to prevent blockage of an assembly station.

This has the advantage that the occurrence of disruptions does not cause blockage of the entire assembly plant. The cause of such a disruption can be, for example, a test of a transportation system that does not proceed faultlessly, or problems in the supply of parts for assembly, or failure to adhere to the standard assembly-time window, or special fittings that usually exceed the standard time window.

It is advantageous for the production control system also to control the material flow. This has the advantage that the status of pre-assembly of a transportation system is known to, and can be inquired of, the production control system at all times. Furthermore, by controlling the material flow, the production control system can monitor the size of the subinventories and order material when needed.

### BRIEF DESCRIPTION OF THE DRAWINGS

The invention is described in detail below in relation to exemplary embodiments and by reference to the annexed drawings, wherein:

FIG. 1 is a diagrammatic side representation of a transportation system on a truss frame;

FIG. 2 is a diagrammatic plan view of an assembly plant with assembly stations, in accordance with the invention;

FIG. 3A is a detail diagrammatic plan view of an assembly station;

FIG. 3B is a detail diagrammatic front elevation view of an assembly station;

FIG. 4 is a flow diagram of an assembly plant with assembly stations and passing stations depicting directions of movement of the transportation systems;

FIG. 5 is a diagrammatical representation of a possible embodiment of a production control and planning system according to the invention;

FIG. 6A is a diagrammatical representation of a first time-sequential procedure according to the invention; and

FIG. 6B is a diagrammatical representation of a second time-sequential procedure according to the invention.

### DETAILED DESCRIPTION OF THE INVENTION

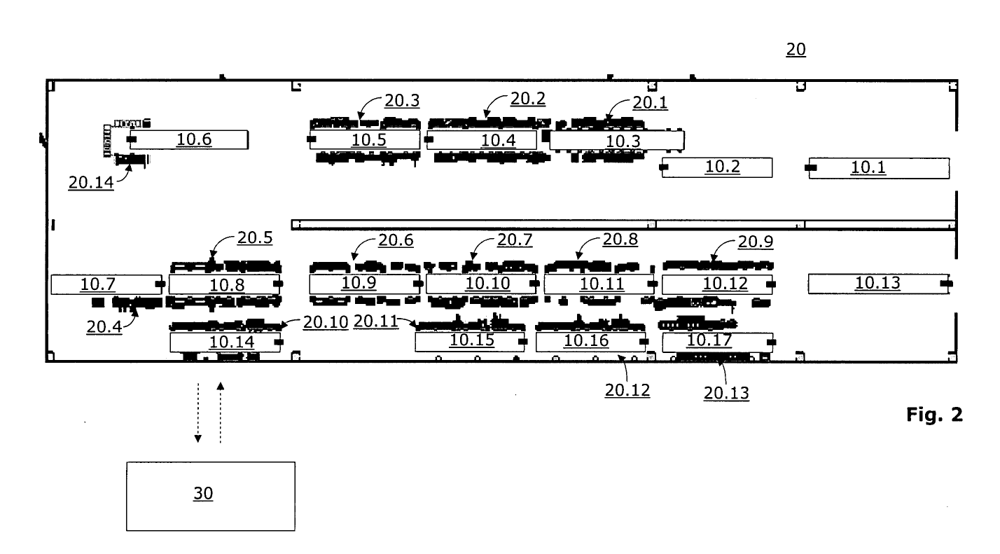

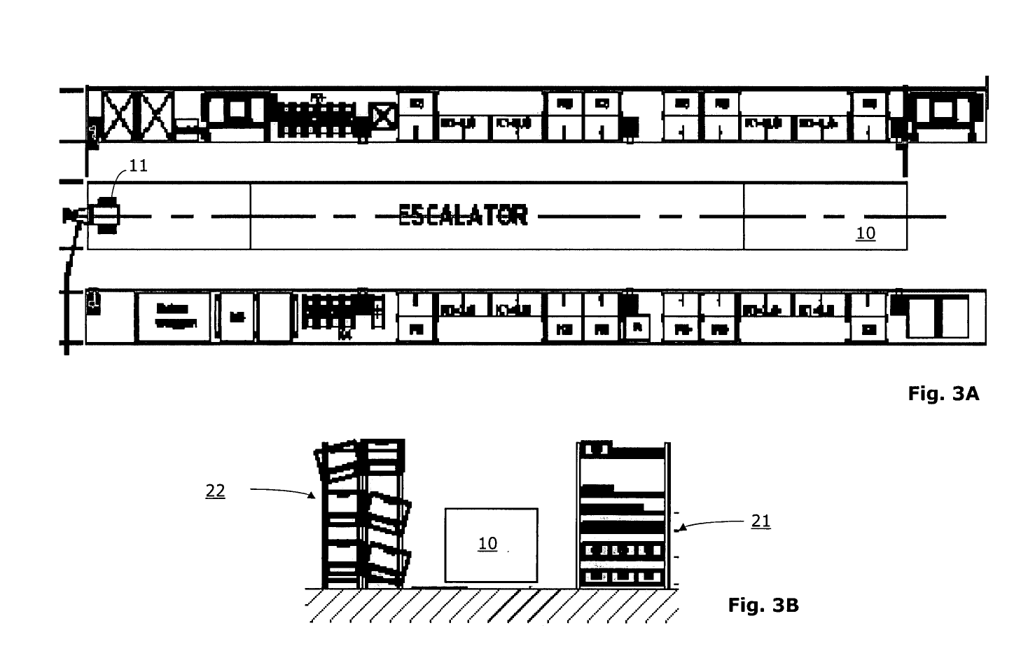

With initial reference to FIG. 2, in accordance with the invention, a production control system 30 is used that comprises software, or in which software can be linked with the production control system 30, to make it possible to plan pre-assembly processes in an assembly plant 20. As part of this planning, the pre-assembly of a transportation system 10 is decomposed into a series of (standardized) basic assembly steps that can be executed for all transportation systems 10. Depending on the desired embodiment or equipment of a transportation system 10 that is to be assembled, all further steps that must be executed are selected or defined. These steps are optional.

The software is preferably designed so that it can determine the time T1 that will be required for the execution of all steps (basic installation steps and optional steps) that will be necessary at an assembly station. Should this time T1 be shorter than a specified standard assembly-time window T, the corresponding steps can, for example, be saved. This process can be repeated for each assembly station 20. The same procedure is carried out for each transportation system 10 that is to be pre-assembled in a time unit (for example, on a certain day) so as to be able to plan the work processes that should be executed during this time unit (for example on a certain day).

The software is preferably designed so that any time-shortages can be detected so as to enable measures to be taken already in the planning phase so as to ensure maintenance of a (production) rhythm T. One measure is, for example, to divide up the time so that a transportation system 10.3 that is very time-intensive to assemble is followed by a transportation system 10.2 that requires less assembly time. The transportation system 10.3 that is time-intensive to assemble may possibly require more time than is foreseen in the standard assembly-time window T. Because a transportation system 10.2 follows that requires less time, the assembly procedure averaged over these two transportation systems 10.2 and 10.3 nonetheless remains within the specified rhythm T.

It is preferable for the software to be so designed that any time shortages can also be detected during the actual assembly to permit corrective intervention. For this purpose, the production control system 30 can make additional resources ready or trigger their being made ready. It is, however, possible to remove a transportation system 10 (at least temporarily) from the production line to allow maintenance of the rhythm T. For this purpose, passing stations (in FIG. 2, for example, the assembly stations 20.10 to 20.13) can be provided. Station 20.4 can, for example, be a test station in which various mechanical and/or electrical function tests can be performed. Should such a test indicate that certain criteria were not fulfilled, correction can take place locally, meaning at the station 20.4, provided that the specified rhythm T allows, i.e. provided that the time T has not yet expired. Otherwise, a transportation system that has not passed the function test can be moved into a passing station (in FIG. 2, for example, the assembly station 20.10). Shown in FIG. 2 is a transportation system 10.14 that is being corrected at the passing station 20.10.

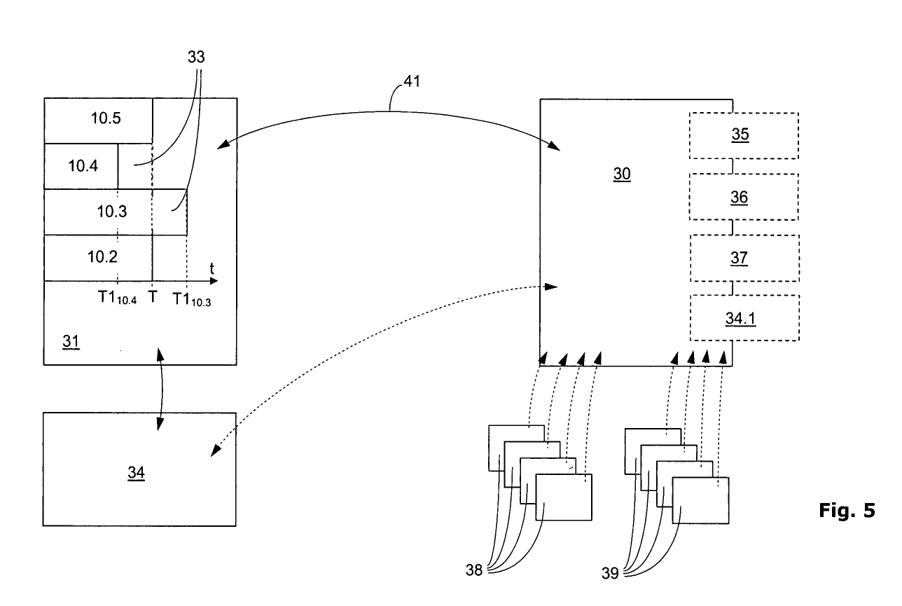

An assembly plant 20 according to the invention preferably comprises a software-based planning system 31 and a software-based production control system 30 as shown in FIG. 5. In a preferred embodiment, these two control systems 30 and 31 are linked together as indicated by the arrow 41. Before production begins, the planning system 31 determines which transportation systems 10 should be produced in sequence at a particular time. The planning system 31 also lays down the duration of a standard assembly-time window T. It is advantageous for this time T to lie between 3 and 4 hours. Particularly preferable is T=approx. 3.5 hours, since in this case, in one working shift at least two transportation systems 10 can be completely pre-assembled and leave the assembly plant 20.

According to the invention, the actual time T1 per transportation system 10 that is required at an assembly station 20.1-20.n for assembly should be less than, or equal to, the standard assembly-time window T so as to remain within a specified rhythm T relative to the entire assembly plant 20. The assembly-times T1 for different transportation systems (10.1-10.m) can, however, differ depending on the transportation system. The planning system 31 knows not only the production times of a standard transportation system 10 but also the production times of possible optional assembly steps. This makes it possible for the planning system 31 to plan the production procedure in such manner that, for example, a transportation system 10.4 that requires less time than the standard assembly-time window T (i.e. T_{10.4}<T) follows a second transportation system 10.3 that requires more time than the standard assembly-time window T (i.e. T_{10.3}>T) or vice versa (so that the total time averaged over two assembly stations T_{10.4}+T_{10.3}<2T). In this way, a limited deviation from the rhythm of the standard assembly-time window is tolerated. In the sum, it should be possible to synchronize the sequentially following transportation systems 10 with the specified standard assembly-time window T, and with the rhythm T, and thereby to prevent the entire assembly plant 20 from deviating from the rhythm.

Depending on its embodiment, the planning system 31 can also help to organize the material flow for the parts that are to be assembled. These can, for example, be obtained from suppliers on a just in time basis. In this case, the planning system 31 serves to order the necessary parts promptly.

Advantageously, the production control system 30 can also be linked to a just-in-time system. It is advantageous for the availability of the parts to be assembled to be indicated to the production control system after they have arrived. Just-in-time means that the parts to be assembled are brought directly to the assembly plant 20 or to the individual assembly stations 20.1-20.n from a goods receiving department without being held in inventory. The outlay for holding inventories can thereby be reduced. The parts must, however, be ordered from the supplier with a certain lead time, and orders can, for example, be triggered or executed by the planning system 31. The lead time designates the time from ordering the parts that are to be assembled until their arrival in the assembly plant 20. The lead time is individual for every part that is to be assembled, and must be correspondingly known when the order is placed and can be taken into account by the planning system 31.

The planning system 31 can, for example, treat each transportation system 10.1-10.n as an individual (data) object, as indicated diagrammatically by the blocks 10.2, 10.3, 10.4, and 10.5 in FIG. 5. Depending on how the planning system 31 is implemented, time deviations (indicated in FIG. 5 by reference number 33) can also be taken into account such as will occur during the pre-assembly of transportation systems requiring less time (e.g. transportation system 10.4 in FIG. 5) and transportation systems requiring more time (e.g. transportation system 10.3 in FIG. 5).

The production control system 30 contains the data for the production of the transportation systems 10.1-10.n, preferably from the planning system 31, as indicated by the arrow 41 in FIG. 5. The production control system 30 can, however, also be operated as a completely autonomous system.

According to the invention, the production control system 30 is designed to monitor and directly control the manufacturing process of several transportation systems 10.1-10.n. Various measures can be available to the production control system 30 to shorten the elapsed assembly-time actually required at an assembly station 20.1-20.n should it be expected that one or more of these assembly stations 20.1-20.n will be blocked by excessively long assembly steps and that the rhythm T will thereby be disrupted.

For example, when time shortages occur in the production process, a so-called jumper team can be ordered to the area of an assembly station 20.1-20.9. These additional assembly workers help to eliminate a blockage existing at an assembly station 20.1-20.9, or to prevent a blockage, and thereby to maintain the defined rhythm T. For this purpose, the production control system 30 can contain a corresponding module (e.g. a software module) 35, as indicated in FIG. 5.

If needed, in the area of the assembly station 20.1-20.n that threatens to become blocked, the production control system 30 can make ready components that are already pre-assembled to a higher degree, or trigger their being made ready. By pre-assembly, the degree of pre-processing of parts to be assembled is increased, so that at the assembly station 20.1-20.n the parts to be assembled can be built in directly as a module. This means that assembly-time that is not available in the assembly stations 20.1-20.n can be outsourced to another workplace. For this purpose, the production control system 30 can contain a corresponding module (e.g. a software module) 36, as outlined in FIG. 5.

A further means of bypassing disruptions in the production process, or of responding to disruptions, can be obtained by means of passing stations 20.10-20.13 (FIG. 2). The passing stations 20.10-20.13 are located in close proximity to the assembly stations 20.1-20.9. This enables the transportation systems 10 to be reintegrated into the production process without great effort after the disruption has been cleared. For this purpose, the production control system 30 can contain a corresponding module (e.g. a software module) 37, as outlined in FIG. 5.

The decision as to which of the previously described measures should be taken in the event of a disruption is preferably made by the production control system 30 itself. Depending on the degree of complexity of the production control system 30, it is, however, also conceivable that a decision by the production control system 30 is affected by a corresponding input. Preferably, however, the production control system 30 is always informed of the current production status, the position of the transportation systems 10.1-10.n and, if such are present, of disruptions in the assembly of transportation systems. In FIG. 5, reference number 38 indicates that the corresponding information about the current positions of the transportation systems 10.1-10.n is passed on to the production control system 30.

The production control system 30 can receive further production-relevant data, for example via a barcode system and/or via sensors. For example, the parts that are required for assembly are equipped with a barcode system. With a barcode reader on the assembly stations 20.1-20.n, the position of the parts for assembly and/or of the work progress is continuously communicated to the production control system 30 as indicated by reference number 39 in FIG. 5. The transportation systems 10 are, for example, equipped with sensors in such manner that the position of the transportation systems 10 can be determined and communicated to the production control system 30, such as by radio waves or via induction loops in the floor as indicated by reference number 39 in FIG. 5.

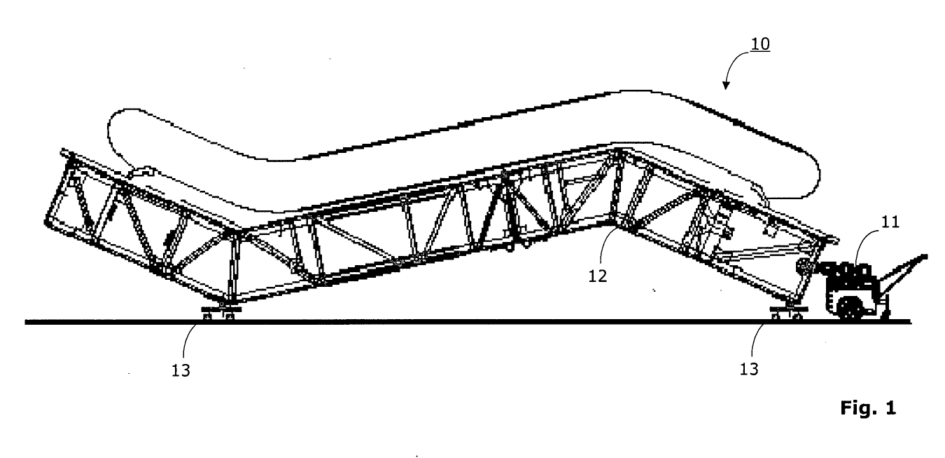

As already implicitly stated, according to the invention, the transportation systems 10 are pre-assembled at the factory in a process with several assembly steps. This pre-assembly is described below by reference to an exemplary embodiment of the invention that is illustrated in FIG. 2. The individual steps are executed in an assembly plant 20 with several assembly stations 20.1-20.13. It is possible for several transportation systems 10.1-10.m (in the exemplary embodiment shown, with m=17) to be present in the assembly plant 20 for pre-assembly simultaneously. As shown in FIG. 1, each transportation system 10 is pre-assembled on truss frames 12 and transported individually from one of the assembly stations 20.1-20.9 to the next following assembly station 20.1-20.9, rollers 13 being preferably mounted on or under the truss frame 12. These truss frames 12 are preferably moved with the aid of at least one transport vehicle 11. It is immaterial whether the transportation systems that are present on the truss frames are moved simultaneously by one transport vehicle respectively, or whether fewer transport vehicles than truss frames are present and the respective transport vehicles are in this case uncoupled and repositioned each time. As a result of a time offset, the second variant results in a wavelike movement of the truss frames from one assembly station to the next within the assembly plant. Because of the different lengths of the transportation systems 10, the truss frames 12 are also correspondingly different in their length.

FIG. 2 depicts an assembly plant 20 in which several transportation systems 10.1-10.17 are shown in several different assembly steps. In the area of the assembly stations 20.1-20.13, station-specific assembly steps are performed on transportation systems 10.1-10.17 that are each momentarily present in the area of the respective assembly station. Between the assembly steps, the transportation systems 10.1-10.17 are moved individually from one assembly station 20.1-20.13 to the next assembly station 20.1-20.13. This movement is referred to as a transfer step. The production control system 30 controls the execution of the assembly steps as well as the execution of the transfer steps. The production control system 30 ensures that the transportation systems 10.1-10.17 are alternately subjected to transfer steps and assembly steps, and that the assembly steps in the assembly plant 20 take place in a defined rhythm T that is defined by a specified fixed standard assembly-time window T. This means that the production control system 30 ensures that the assembly of the transportation systems 10.1-10.17 proceeds in a synchronized manner, even though normally no one transportation system is necessarily the same as another.

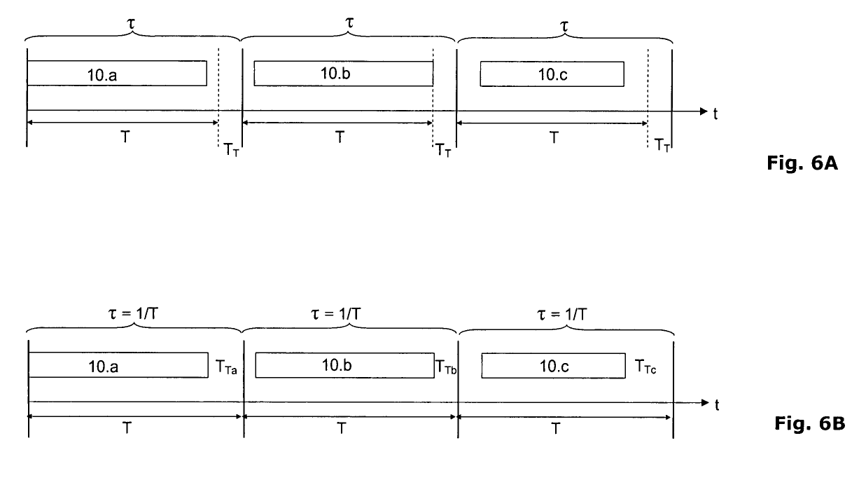

Shown in FIGS. 6A and 6B are two methods that can be realized with a control system according to the invention.

In FIG. 6A a differentiation is made between standard assembly-time windows T and transfer time windows T_{T}. The rhythm T results as follows: T=1/(T+T_{T}). It is advantageous for the time T to lie between 3 and 4 hours. Particularly preferred is T=approx. 3.5 hours. The transfer time can be, for example, T_{T}=0.25 hours or T_{T}=0.5 hours. Also indicated diagramatically in FIG. 6A is that the transportation systems 10.a, 10.b, and 10.c require different lengths of time for the execution of station-specific assembly steps in the area of the assembly stations. In the example shown, T_{10.a}<T, T_{10.b}<T, and T_{10.c}<T. In other words, none of the transportation systems shown requires a greater length of time than is foreseen by the specified standard assembly-time window T. It is also apparent from FIG. 6A that the transportation system 10.awill be finished earlier and, as a result, somewhat more time will be available for execution of the transfer step. The transportation system 10.acan obviously only be moved into the next assembly station if the latter is free. The assembly of transportation system 10.bdoes not start at the beginning of the rhythm T, but with some delay. The reason may be, for example, that the time taken by the transfer step was longer. The assembly of transportation system 10.calso does not start at the beginning of the rhythm T, but with some delay. This transportation system 10.crequires only a small amount of time for its assembly and is therefore finished long before the end of the standard assembly-time window T.

In FIG. 6B, no differentiation is made between standard assembly-time windows T and transfer time windows T_{T}. The rhythm T results as follows: T=1/T. The remaining time in the standard assembly-time window T is referred to as the transfer time T_{Ta} to T_{Tc} and is used for execution of the transfer. In this embodiment it is advantageous for the time T to lie between 3 and 5 hours. Particularly preferred is T=approx. 4 hours.

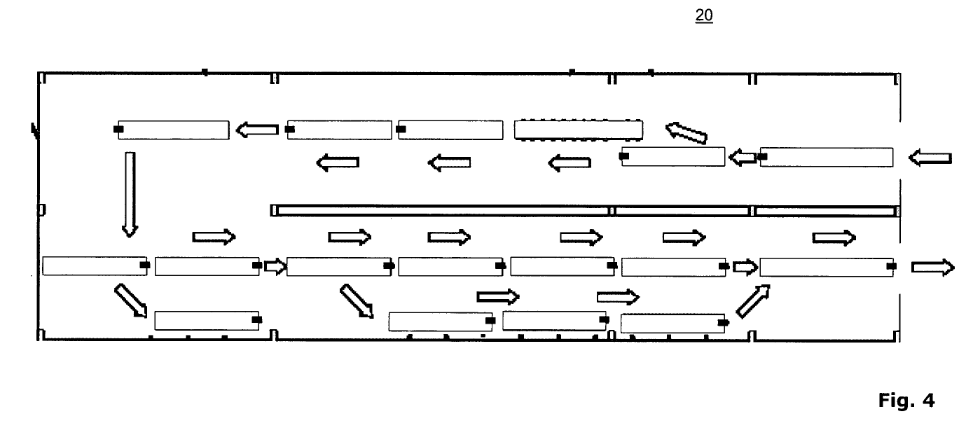

Shown in FIG. 4 is a further exemplary assembly plant 20. In FIG. 4, the movement of the transportation systems is indicated by open arrows and the individual transportation systems are represented by rectangles. The length of the open arrows indicates the duration of a transfer step.

The individual elements and aspects of the various embodiments can be freely combined together to provide an assembly plant that takes specific account of the respective need.

We claim:

1. A method of at-factory pre-assembly in several assembly steps of a transportation system embodied as an escalator or moving walk, executable in an assembly plant with a plurality of assembly stations, there being simultaneously present in the assembly plant for pre-assembly a plurality of transportation systems, characterized by the following steps:
execution in an area of each assembly station of station-specific assembly steps on a transportation system that is momentarily present in the area of the respective assembly station; and
execution of transfer steps to move the transportation systems individually from one assembly station to a following assembly station, the execution of the assembly steps and the execution of the transfer steps being controlled by a production control system in such manner that the transportation systems are alternately subjected to transfer steps and assembly steps and that the assembly steps take place in the assembly plant in a rhythm (T) that is defined by a specified fixed standard assembly-time window (T).

2. The method according to claim 1, characterized in that
the assembly steps are decomposed into standard assembly-time windows (T) and that the production control system comprises means for controlling the assembly the transportation systems to proceed in a time-synchronized manner.

3. The method according to claim 2, characterized in that
the production control system monitors and controls the assembly of the transportation systems in such manner that, on expiration of a standard assembly-time window (T), transfer steps are executed to move the transportation systems individually to the respective next assembly station.

4. The method according to claim 2 or 3, characterized in that the transfer steps are executed time-displaced one after the other at the individual assembly stations so that the transfer steps move through the assembly plant in a wave-like motion.

5. The method according to claim 2 or 3, characterized in that the production control system shortens the actual elapsed time required for assembly at an assembly station if it is expected that the assembly station will be blocked by assembly steps of excessive duration and that thereby the rhythm (T) would be disrupted.

6. The method according to claim 5, characterized in that
in the area of the assembly station which is expected to become blocked, the production control system triggers or makes ready additional resources.

7. The method according to claim 5, characterized in that
in the area of the assembly station which is expected to become blocked, the production control system makes ready pre-assembled components to a higher degree or triggers their being made ready.

8. The method according to claim 5, characterized in that
in the area of the assembly station which is expected to become blocked, the production control system makes ready additional assembly workers or triggers their being made ready.

9. The method according to claim 1, 2 or 3, characterized in that the production planning system controls the assembly plant in a manner that, following a transportation system that is time-intensive to assemble, a transportation system that is less time-intensive to assemble passes through the assembly stations so as to remain within the defined rhythm (T).

10. An assembly plant for at-factory pre-assembly of transportation systems embodied as escalators or moving walks having a plurality of assembly stations for pre-assembly of parts of a transportation system and a production planning system wherein:
the assembly stations are arranged in the sequence of the assembly steps that are to be executed; possess assembly-step-specific tool devices; and have devices to make ready an inventory of assembly-step-specific assembly components; and
the production planning system is linked with at least one of the assembly stations and comprises means to control or trigger execution of the assembly steps and individual movement of the transportation systems from one assembly station to a following assembly station in such a manner that each transportation system is alternately moved and subjected to assembly steps, and the assembly steps proceed in a rhythm (T) that is defined by a specified fixed standard assembly-time window (T).

11. The assembly plant according to claim 10, characterized in that it contains at least one transport vehicle for individually moving a transportation system to be pre-assembled from one assembly station to the next following assembly station.

12. The assembly plant according to claim 10 or 11, characterized in that the production control system is a computer aided production control system having at least one of a sensor or output unit to control, and correctively intervene in, the pre-assembly of the transportation systems.

13. The assembly plant according to claim 10 or 11, further comprising movable truss frames for mounting and transporting the transportation systems.

14. The assembly plant according to claim 10 or 11, wherein the inventory make ready devices operate according to the Kanban principle.

15. The assembly plant according to claim 10 or 11, wherein the production control system is linked to a just-in-time system for the purpose of reducing outlay for inventory holding.

16. The assembly plant according to claim 10 or 11, wherein the production control system includes means for triggering a readying of material that is required at a respective assembly station sufficiently promptly such that no delays occur in the assembly process.

17. The assembly plant according to claim 10 or 11, characterized in that at least one of the following assembly stations is present:
a preparation station;
a station for the installation of electrical components;
a station for the mounting of balustrades and/or steps;
a test station for testing pre-assembled transportation systems;
a packing station.

18. An assembly plant according to claim 17, characterized in that at least one passing station is provided for the purpose of temporarily removing a transportation system from the pre-assembly process so as to avoid blockage of an assembly station.

19. An assembly plant according to claim 10 or 11, characterized in that the production control system also contains means to monitor and control material flow.
